(19) United States
(12) Patent Application Publication
(10) Pub. No.: US 2011/0040833 A1
(43) Pub. Date: Feb. 17, 2011

(54) Methods and Arrangements for Interactive Caller Information Services in a Communication Network

(75) Inventors: Calin Curescu, Solna (SE); Farjola Zaloshnja, Solna (SE); Ignacio Mas Ivars, Tullinge (SE); Mikael Woxblom, Alvsjo (SE)

Correspondence Address: COATS & BENNETT, PLLC, 1400 Crescent Green, Suite 300, Cary, NC, 27518, US

(73) Assignee: TELEFONAKTIEBOLAGET LM ERICSSON (PUBL), Stockholm (SE)

(21) Appl. No.: 12/988,851

(22) PCT Filed: Apr. 25, 2008
(86) PCT No.: PCT/SE08/50478

§ 371 Date: Oct. 21, 2010

(51) Int. Cl. G06F 15/16

(52) U.S. Cl. 709/203

(57) ABSTRACT

The present invention relates to methods and arrangements for providing caller information to a SIP enabled client (320), e.g. an IPTV client, in a communication network (10). The SIP enabled client (320) is connected to a SIP communication client (310), e.g. a VoIP client, in a home network (300). When another SIP communication client (100) in the communication network (10) calls the VoIP client (310) the call is forwarded to the VoIP client and forked to a caller ID application server (200). As the IPTV client has registered for a subscription to caller information on communication destined to the VoIP client in the home network, it receives caller information of the SIP communication client (100) from the caller ID application server (200) if the VoIP client has enabled the caller information functionality.

### TECHNICAL FIELD

The present invention relates to a communication network comprising an IP Multimedia Subsystem (IMS). In particular, it relates to methods and arrangements in the IMS network for providing caller information to SIP enabled clients.

### BACKGROUND

The IP Multimedia Subsystem (IMS) is an architectural framework for delivering Internet Protocol (IP) multimedia to mobile users. It was originally designed by the wireless standards body 3rd Generation Partnership Project (3GPP), and is part of the vision for evolving mobile networks beyond GSM. Its original formulation (3GPP R5) represented an approach to delivering “Internet services” over GPRS. This vision was later updated by 3GPP, 3GPP2 and TISPAN by requiring support of networks other than GPRS, such as Wireless LAN, CDMA2000 and fixed line.

To ease the integration with the Internet, IMS as far as possible uses IETF (i.e. Internet) protocols such as Session Initiation Protocol (SIP). According to the 3GPP, IMS is intended to aid the access of multimedia and voice applications across wireless and wireline terminals. The Session Initiation Protocol (SIP) is an application-layer control signaling protocol for creating, modifying, and terminating sessions with one or more participants. It can be used to create two-party, multiparty, or multicast sessions that include Internet telephone calls, multimedia distribution, and multimedia conferences. SIP is designed to be independent of the underlying transport layer; it can run on TCP, UDP, or SCTP. It is widely used as a signaling protocol for Voice over IP (VoIP), along with H.323 and others.

A home network, i.e. a residential local area network, is used to connect multiple devices like Internet telephones, Set-Top Box TVs, pagers and PCs within a home. As networking technology evolves, more electronic devices and home appliances are becoming SIP ready and accessible through the home network. An advantage of an IMS network is the opportunity for integration and convergence. Converged services imply interaction of existing services in a seamless manner to create new value added services. One example is On-Screen Caller ID, getting caller ID on the IPTV. Caller ID (caller identification, CID, or more properly calling number identification) is a service that transmits a caller's number to the called party's client device. The information made available to the called party may be made visible on a display of a telephone or on a separate attached client device. Caller ID support among VoIP providers varies, although the majority of VoIP providers now offer full caller ID with name on outgoing calls.

However, existing solutions for providing caller ID are often proprietary and work exclusively for the particular application they are targeted to. Moreover, the solutions require that the telephone call signaling traverses the device that will display the caller ID in order for the device to be able to extract the caller ID.

Other solutions fork the call to additional devices apart from the call receiving telephone and put additional requirements on the application routing nodes. The nodes need to maintain state information for each branch of the forked call even though the majority of the additional devices only want to retrieve caller ID and are not able to establish the call.

Moreover, the caller ID added services may add a delay to the initial service, i.e. the telephone call.

### SUMMARY

Thus the object of the present invention is to achieve an improved solution for providing caller information to a client device in a communication network.

The basic idea with the present invention is to let a SIP router, which is in charge of routing a call from a first device in a communication network to a second device in a home network, fork the call to a general caller ID SIP application server. The caller ID application server receives the call and extracts caller information of the devices. Further, the application server delivers the caller information to interested clients in the home network. The interested client has requested the caller information beforehand and receives caller information of the caller calling the second device.

According to a first aspect of the present invention a method for an application server is provided. In the method a request to send the SIP enabled client caller information on communication destined to the second SIP communication client is sent. The request to send the SIP enabled client caller information on communication destined to the second SIP communication client is stored. A call request from a node in the communication network to the second SIP communication client from the first SIP communication client is received. The identity of the second SIP communication client is retrieved. Further the identity of the second SIP communication client is mapped with the stored request to determine the SIP enabled client that is associated with the second SIP communication client. The caller information of the first SIP communication client according to the stored request is retrieved and the caller information of the first SIP communication client is sent to the SIP enabled client.

According to a second aspect of the present invention an application server for providing caller information is provided. The application server comprises means for receiving a request to send the SIP enabled client caller information on communication destined to the second SIP communication client, means for storing the request to send the SIP enabled client caller information on communication destined to the second SIP communication client, and means for receiving from a node in the communication network a call request to the second SIP communication client from the first SIP communication client. It further comprises means for retrieving the identity of the second SIP communication client, means for mapping the identity of the second SIP communication client with the stored request to determine the SIP enabled client that is associated with the second SIP communication client, means for retrieving caller information of the first SIP communication client according to the stored request, and means for sending the caller information of the first SIP communication client to the SIP enabled client.

According to a further aspect of the present invention a method for a SIP enabled client is provided. In the method a request to send the SIP enabled client caller information on communication destined to the second SIP communication client is sent to an application server. The application server is configured to determine the SIP enabled client that is associated with the second SIP communication client to retrieve caller information of the first SIP communication client. Further when the first SIP communication client calls the second SIP communication client the caller information of the first SIP communication client is received.

According to a further aspect of the present invention a SIP enabled client is provided. The SIP enabled client comprises means for sending to an application server, which is configured to determine the SIP enabled client that is associated with the second SIP communication client to retrieve caller information of the first SIP communication client, a request to send the SIP enabled client caller information on communication destined to the second SIP communication client. It further comprises means for receiving the caller information of the first SIP communication client when the first SIP communication client calls the second SIP communication client.

According to a further aspect of the present invention a computer program product directly loadable into a processing means within a server and/or a router is provided. It comprises the software code means for performing the steps of any of the methods of the present invention.

According to a further aspect of the present invention a computer program product stored on a computer usable medium is provided. It comprises readable program for causing a processing means in a communication network, to control the execution of the methods of the present invention.

An advantage with the present invention is that it separates the devices which are capable of receiving and answering a call from the devices only interested in receiving information on a calling device. This rationalizes the use of caller information in a communication network and introduces a scalable way of managing the caller information service.

A further advantage that facilitates the scalability of the caller information service is that the caller information service is managed in a separate caller ID application server and does not interfere with the routing of the calls in the SIP router.

A further advantage is that the present invention allows devices to subscribe on different types of caller information of a plurality of calling devices.

A further advantage is that the initial call is not affected by the signalling of the caller information service i.e. the caller information service is transparent to the initial call. The initial call to the receiving client proceeds independently of the caller information service functionality without any additional delays or other performance metrics.

A yet further advantage is that the present invention is based on standard SIP functionality which enables a generalized deployment in any SIP compliant device.

### BRIEF DESCRIPTION OF THE DRAWINGS

The invention will in the following be described in more detail with reference to enclosed drawings, wherein:

FIG. 1 illustrates the present invention in a communication network.

FIG. 2 shows the method for the application server according to embodiments of the present invention.

FIG. 3 shows the method for the SIP enabled client according to embodiments of the present invention.

FIG. 4 shows the application server according to embodiments of the present invention.

FIG. 5 shows the SIP enabled client according to embodiments of the present invention.

### DETAILED DESCRIPTION

In the following description, for purposes of explanation and not limitation, specific details are set forth, such as particular sequences of steps, signalling protocols and device configurations in order to provide a thorough understanding of the present invention. It will be apparent to one skilled in the art that the present invention may be practised in other embodiments that depart from these specific details.

Moreover, those skilled in the art will appreciate that the functions explained herein below may be implemented using software functioning in conjunction with a programmed microprocessor or general purpose computer, and/or using an application specific integrated circuit (ASIC). It will also be appreciated that while the current invention is primarily described in the form of methods and devices, the invention may also be embodied in a computer program product as well as a system comprising a computer processor and a memory coupled to the processor, wherein the memory is encoded with one or more programs that may perform the functions disclosed herein.

The present invention is described with methods and arrangements that use SIP signaling. However, it should be noted that the invention is applicable to both simple SIP and full IMS clients.

The methods and arrangements according to the present invention will also be described with reference to a home network, which should be seen as non-limiting example of local area networks.

The present invention relates to let a SIP router, which is in charge of routing a call from a first device in a communication network to a second device in a home network, fork the call to a general caller ID SIP application server. The caller ID application server receives the call and extracts caller information of the devices. Further, the application server delivers the caller information to interested clients in the home network. The interested client has requested the caller information beforehand and receives caller information of all callers calling the second device.

In the following different preferred embodiments of the present invention will be described.

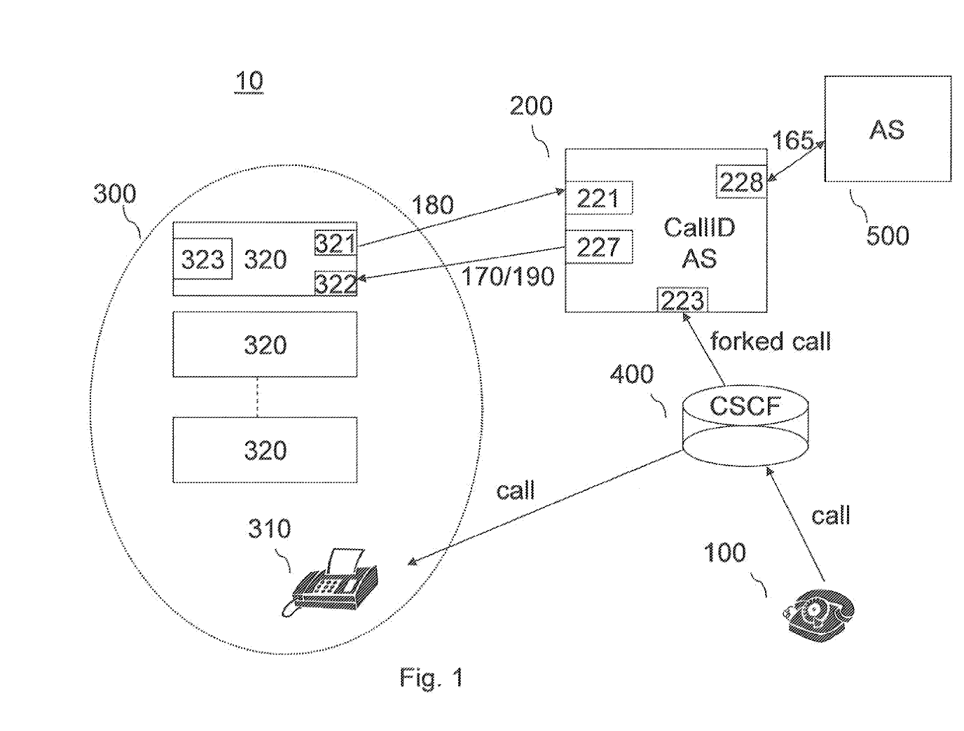

Illustrated in FIG. 1 is a communication network 10 which comprises a home network 300 which consists of a plurality of connected devices 310, 320. The devices could be Internet telephones, set-top box TVs, pagers and computers etc. A plurality of the devices 320 could be SIP enabled clients i.e. clients that can process and understand the SIP protocol. Some of the devices could be SIP communication client 310 used for communication with other SIP communication clients 100 in the communication network 10. It should be pointed out that a SIP communication client is a SIP enabled client that can also accept incoming and establish outgoing communication media streams.

In an exemplifying scenario pictured in FIG. 1, a user of a SIP enabled device 320, for example an IPTV, in the home network 300 would like to receive information on who is calling another device i.e. a SIP communication client 310, for example a VoIP client, in the home network 300. The VoIP client 310 could be a telephone, a computer program or a set-top box etc, as long as it has SIP communication capabilities.

Firstly, the VoIP client 310 has to enable caller information functionality if it should be possible for the IPTV device 320 to receive information on who is calling the VoIP client 310 and further additional information about the caller.

Thus, a SIP REGISTER request is sent from the VoIP client 310 to a node 400 in the communication network 10 when the VoIP client 310 logs on to the home network 300. The node is a SIP server 400, which could be a CSCF (Call Session Control Function) server. The CSCF server processes SIP signaling packets in the communication network 10. Consequently, when the CSCF server 400 receives the SIP REGISTER request from the VoIP client 310, a SIP registrar in the server 400 updates the initial filter criteria in the registrar to fork every call made to the VoIP client 310 towards a caller ID application server 200. The SIP public service identity of the caller ID application server is preconfigured in the CSCF when provisioning the service.

The caller ID application server 200 provides caller information on communication destined to the VoIP client 310 to an interested client 320. The interested client 320 has requested the caller information and the caller ID application server 200 has stored the request for the information to be included in the caller information.

The caller information could be a plurality of different types of information such as caller identification, geographical information or name information etc. The caller ID application server 200 maintains watcher state information for every SIP communication client 310 that has caller ID functionality enabled. The watcher is a client that is interested in receiving updates when a piece of information changes. The application server 200 maintains the list of clients that are interested in receiving the caller information. In addition, the application server 200 could interact 165 with other application servers 500 in the communication network 10 and retrieve caller information from them. In one embodiment, parts of the caller information is retrieved from another server application 500 and the requested caller information is created together with additional parts of information retrieved in the caller ID application server 200.

The caller ID application server could be a stand alone server or collocated with other servers in the network, for example a MMTEL (IMS multimedia telephony) application server or an IPTV application server.

Secondly, when the user of the device 320, i.e. the IPTV client, would like to receive information on communication destined to the VoIP client 310 on a display of the device 323, e.g. a TV screen, he requests 180 the caller information he is interested in. In one embodiment of the present invention, the request 180 is a subscription request to subscribe on caller information on communication destined to the client 310. To make the subscription the IPTV client 320 sends a request 180, i.e. a SIP SUBSCRIBE, towards the caller ID application server 200. It should be noted that the request could be sent from another client 320 than the IPTV client in the home network requesting caller information to the IPTV client.

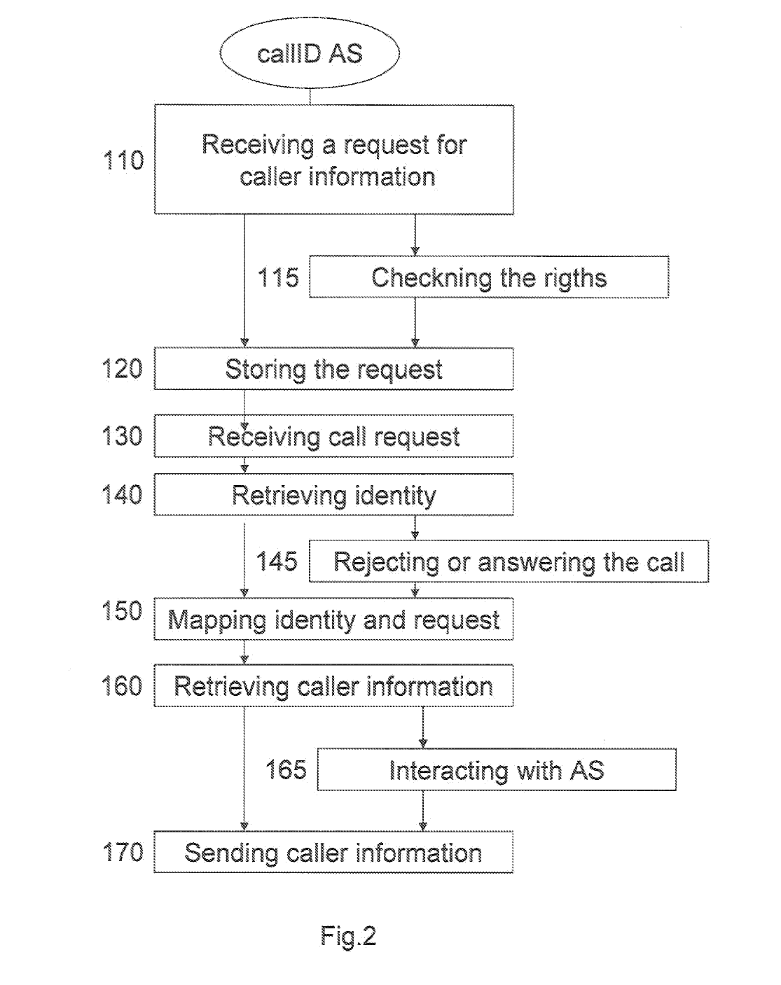

The request for caller information is received 110 and stored 120 in the caller ID application server 200 as shown in FIG. 2. There are several known methods for storing information known to the person skilled in the art that might be applicable, such as in local memory, on the file system or in a database.

Finally, referring to FIGS. 1 and 2, when a call is placed from another SIP communication client 100 in the communication network 10 towards the registered VoIP client 310 the SIP router in the SIP server 400 forks the call towards the caller ID application server 200. The original call is still forwarded to the receiving device, i.e. the VoIP client 310, as shown in FIG. 1. The call, which is forked to the caller ID application server 200, is received 130 in the caller ID application server 200. The caller ID application server 200 retrieves 140 the identities of both the calling SIP client 100 and the called VoIP client 310 and then rejects 145 the call, thereby closing the forked call to the caller ID application server 200. In an embodiment of the present invention the caller ID application server 200 could answer the call request instead of rejecting the call request.

Furthermore, the caller ID application server 200 maps 150 the retrieved identity of the called VoIP client 310 with the stored requested caller information on communication destined to the called client 310 to determine the IPTV client 320. Additionally, the caller ID application server 200 retrieves 160 the caller information of the SIP communication client 100 by the use of the retrieved identity of the SIP communication client 100 according to the stored request.

It should be noted that there could be several SIP communication clients 320 that have requested caller information. The requested type of caller information could differ among the clients 320. The caller ID application server 200 retrieves the caller information according to each stored request respectively.

The caller ID application server sends 170 a SIP NOTIFY message to every client 320 that has requested caller information on communication to the called VoIP client 310. The SIP NOTIFY message contains caller information linked to the calling SIP communication client 100 such as caller identification. In an embodiment of the present invention extended information in the SIP NOTIFY message could be provided by interaction 165 with another application server 500. For example, a geographical location of the calling SIP communication client 100 or a network address book can be queried to retrieve the name associated with the caller identification of the calling SIP communication client 100.

In one embodiment, the caller ID application server 200 utilizes standard SIP functionality to check 115 if the IPTV client 320 has the rights to receive the caller information on the communication destined to the VoIP client 310 and if the client 320 does not have the rights to receive the information the request is denied.

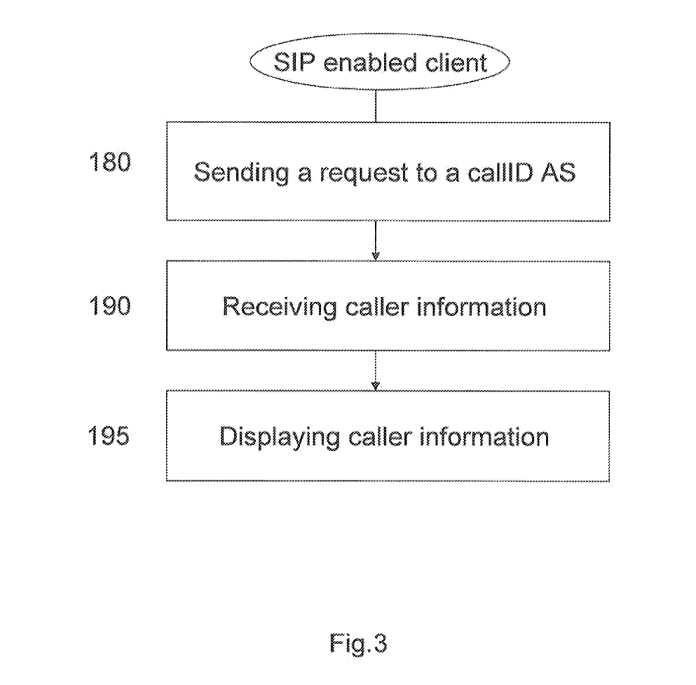

Illustrated in FIG. 3, each client 320 receiving 190 the caller information in a SIP NOTIFY message uses the caller information accordingly to its configurations parameters. The received information could be offered for consumption by different methods in the device 320. For example, it could be displayed 195 to the user in form of visible information on a display 323, or be presented in form of an audio signal or logged in the device etc.

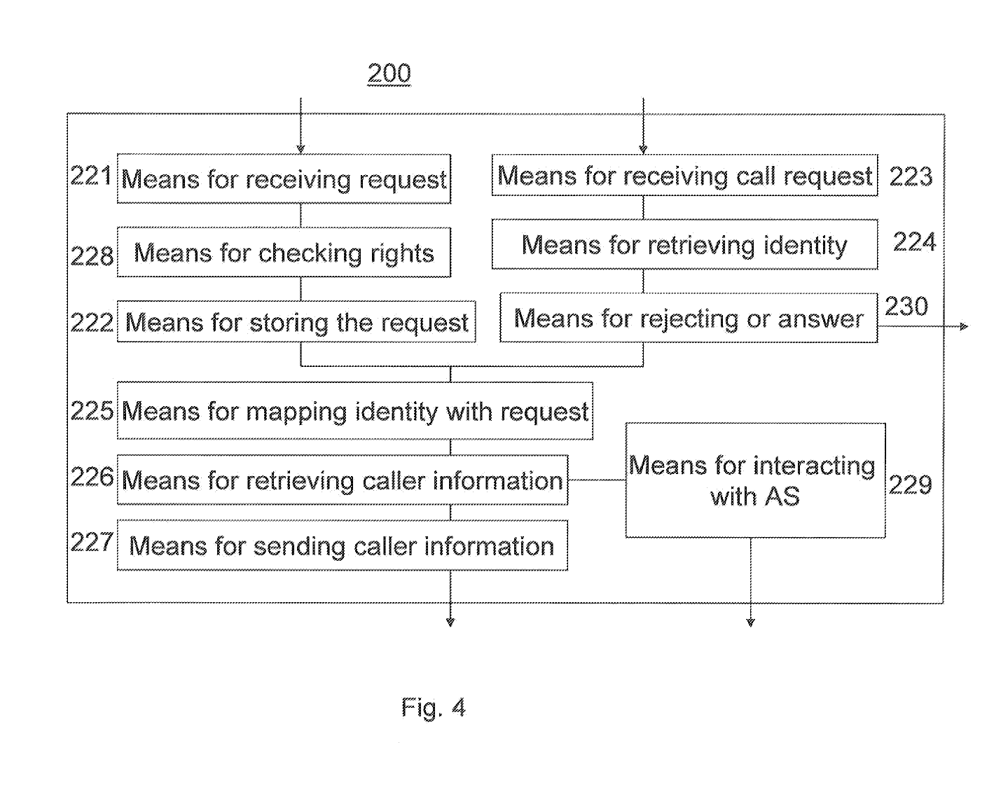

As shown in FIG. 4 the caller ID application server 200 comprises means 221 for receiving and storing a request to send the IPTV client 320 caller information on communication destined to the VoIP client 310. The application server 200 further comprises means 223 for receiving from the SIP server 400 a call request to the VoIP client 310 from the SIP communication client 100 and means 224 for retrieving the identity of the VoIP client 310. It comprises additionally means 225 for mapping the identity of the VoIP client 310 with the stored request that is associated with the VoIP client 310 to determine the IPTV client 320 and means 226 for retrieving caller information of the SIP communication client 100 according to the stored request. Further the application server 200 comprises means 227 for sending the caller information of the first SIP communication client 100 to the IPTV client 320.

In one embodiment of the present invention the application server 200 comprises means 228 for checking if the IPTV client 320 has the rights to be sent the caller information and means 229 for interacting with at least a second application server 500. Additionally, the caller ID application server 200 could comprise means 230 for rejecting or answering the call request.

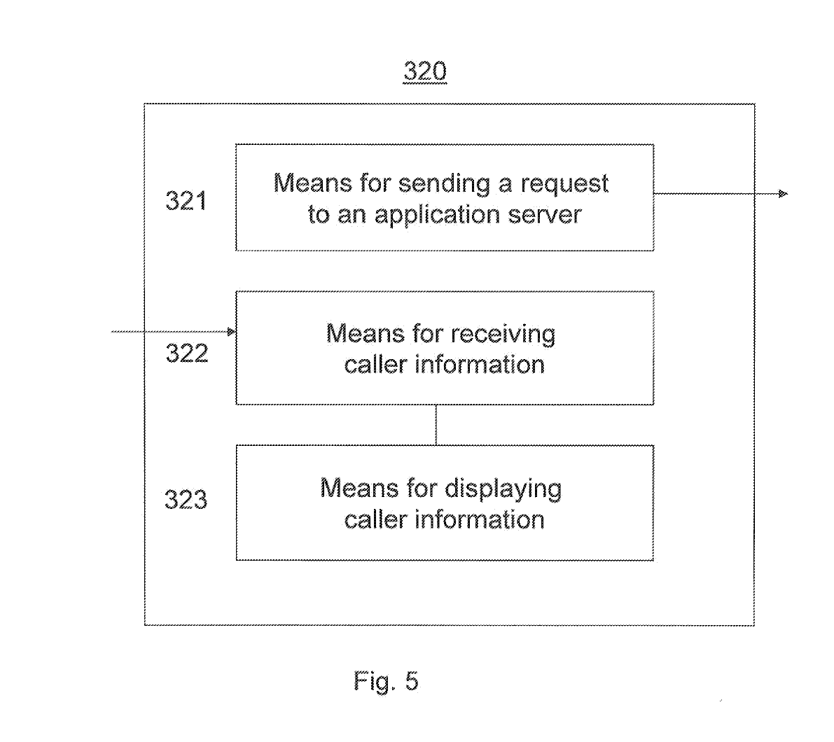

The IPTV client 320 is shown in FIG. 5. The client comprises means 321 for sending a request to send the IPTV client 320 caller information on communication destined to the VoIP client 310 to the application server 200 according to the present invention and means 322 for receiving the caller information of the SIP communication client 100 when the SIP communication client 100 calls the VoIP client 310.

In one embodiment of the present invention the IPTV client 320 comprises means 323 for displaying the caller information on a display associated with the IPTV client 320.

It should be noted that the call signaling does not need to traverse the devices 320 that are interested in the caller information. The call signaling is forwarded from the SIP server 400 to the called SIP communication client 310 and forked to the caller ID server application and not to every single device 320 which simply wants to retrieve the caller information and not establish the call. Thus, the present invention reduces the signaling requirements on the application routing nodes such as the SIP server 400. In addition, the present invention reduces the amount of forked branches of a call and thereby decreases the need of keeping state of each branch of the forked call. Moreover, this is done without interfering with the original call signaling. The caller ID application server immediately rejects the call without forwarding or forking it further to the devices 320. Thus the forked call to the application server 200 does not introduce delays in the original call.

While the present invention has been described with respect to particular embodiments (including certain device arrangements and certain orders of steps within various methods), those skilled in the art will recognize that the present invention is not limited to the specific embodiments described and illustrated herein. Therefore, it is to be understood that this disclosure is only illustrative. Accordingly, it is intended that the invention be limited only by the scope of the claims appended hereto.

1-22. (canceled)

23. A method in a Session Initiation Protocol (SIP) application server for providing caller information in a communication network to at least one SIP enabled client in a home network, wherein the communication network comprises at least a first SIP communication client, which is able to call at least a second SIP communication client in the home network, the method comprising:
receiving a request from the SIP enabled client, wherein the request is a subscription request to subscribe to caller information on communication destined to the second SIP communication client,
storing the request to send the SIP enabled client caller information on communication destined to the second SIP communication client,
receiving from a node in the communication network a call request to the second SIP communication client from the first SIP communication client,
retrieving the identity of the second SIP communication client,
mapping the identity of the second SIP communication client with the stored request to determine the SIP enabled client that is associated with the second SIP communication client,
retrieving caller information of the first SIP communication client according to the stored request, and
sending the caller information of the first SIP communication client to the SIP enabled client.

24. The method according to claim 23, further comprising:
rejecting or answering the call request.

25. The method according to claim 23, further comprising
checking if the SIP enabled client has the rights to be sent the caller information.

26. The method according to claim 23, wherein the caller information of the first SIP communication client is information linked to the SIP communication client and includes at least one of caller identification, geographical location or name information.

27. The method according to claim 23, wherein the SIP enabled client or either the first or second SIP communication client is a VoIP client, IPTV client, set-top box or computer.

28. The method according to claim 23, further comprising:
interacting with at least a second application server and retrieving at least a part of the caller information from the second application server.

29. An Session Initiation Protocol (SIP) application server for providing caller information in a communication network to at least one SIP enabled client in a home network, wherein the communication network comprises at least a first SIP communication client, which is able to call at least a second SIP communication client in the home network, the SIP application server configured to:
receive a request from the SIP enabled client, wherein the request is a subscription request to subscribe to caller information on communication destined to the second SIP communication client,
store the request to send the SIP enabled client caller information on communication destined to the second SIP communication client,
receive from a node in the communication network a call request to the second SIP communication client from the first SIP communication client,
retreive the identity of the second SIP communication client,
map the identity of the second SIP communication client with the stored request to determine the SIP enabled client that is associated with the second SIP communication client,
retreive caller information of the first SIP communication client according to the stored request, and
send the caller information of the first SIP communication client to the SIP enabled client.

30. The application server according to claim 29, wherein the SIP application server is further configured to reject or answer the call request.

31. The application server according to claim 29, wherein the SIP application server is further configured to check if the SIP enabled client has the rights to be sent the caller information.

32. The application server according to claim 29, wherein the caller information of the first SIP communication client is information linked to the SIP communication client and includes at least one of caller identification, geographical location or name information.

33. The application server according to claim 29, wherein the SIP enabled client or either the first or second SIP communication client is a VoIP client, IPTV client, set-top box or computer.

34. The application server according to claim 29, wherein the SIP application server is further configured to interact with at least a second application server and retrieve at least a part of caller information from the second application server.

35. A method for a Session Initiation Protocol, SIP, enabled client in a home network for receiving caller information of at least a first SIP communication client in a communication network, wherein the first SIP communication client is able to call at least a second SIP communication client in the home network, the method comprising:
sending to a SIP application server, configured to determine the SIP enabled client that is associated with the second SIP communication client and retrieve caller information of the first SIP communication client, a SIP subscription request to send the SIP enabled client caller information on communication destined to the second SIP communication client, and
receiving the caller information of the first SIP communication client when the first SIP communication client calls the second SIP communication client.

36. The method according to claim 35, further comprising either displaying the caller information on a display associated with the SIP enabled client, issuing an audio signal, or logging the caller information.

37. The method according to claim 35, wherein the caller information of the first SIP communication client is information linked to the SIP communication client and includes at least one of caller identification, geographical location or name information.

38. The method according to claim 35, wherein the SIP enabled client or either the first or second SIP communication client is a VoIP client, IPTV client, set-top box or computer is an IPTV client, set-top box or computer.

39. A Session Initiation Protocol, SIP, enabled client in a home network for receiving caller information of at least a first SIP communication client in a communication network, wherein the first SIP communication client is able to call at least a second SIP communication client in the home network, the SIP enabled client configured to:
send to a SIP application server, configured to determine the SIP enabled client that is associated with the second SIP communication client and retrieve caller information of the first SIP communication client, a SIP subscription request to send the SIP enabled client caller information on communication destined to the second SIP communication client, and
receive the caller information of the first SIP communication client when the first SIP communication client calls the second SIP communication client.

40. The SIP enabled client according to claim 39, wherein the SIP enabled client is further configured to display the caller information on a display associated with the SIP enabled client.

41. The SIP enabled client according to claim 39, wherein the caller information of the first SIP communication client is information linked to the SIP communication client and includes at least one of caller identification, geographical location or name information.

42. The SIP enabled client according to claim 39, wherein the SIP enabled client or either the first or second SIP communication client is a VoIP client, IPTV client, set-top box or computer is an IPTV client, set-top box or computer.

43. A computer program product stored on a computer usable medium, comprising a readable program for causing one or more processors in a communication network to control a Session Initiation Protocol (SIP) application server to provide caller information in the communication network to at least one SIP enabled client in a home network, wherein the communication network comprises at least a first SIP communication client, which is able to call at least a second SIP communication client in the home network, the readable program causing the one or more processors to control the SIP application server to:
receive a request from the SIP enabled client, wherein the request is a subscription request to subscribe to caller information on communication destined to the second SIP communication client,
store the request to send the SIP enabled client caller information on communication destined to the second SIP communication client,
receive from a node in the communication network a call request to the second SIP communication client from the first SIP communication client,
retrieve the identity of the second SIP communication client,
map the identity of the second SIP communication client with the stored request to determine the SIP enabled client that is associated with the second SIP communication client,
retrieve caller information of the first SIP communication client according to the stored request, and
send the caller information of the first SIP communication client to the SIP enabled client.

44. A computer program product stored on a computer usable medium, comprising a readable program for causing one or more processors in a communication network to control a Session Initiation Protocol (SIP) enabled client in a home network for receiving caller information of at least a first SIP communication client in a communication network, wherein the first SIP communication client is able to call at least a second SIP communication client in the home network, the readable program causing the one or more processors to control the SIP enabled client to:
send to a SIP application server, configured to determine the SIP enabled client that is associated with the second SIP communication client and retrieve caller information of the first SIP communication client, a SIP subscription request to send the SIP enabled client caller information on communication destined to the second SIP communication client, and
receive the caller information of the first SIP communication client when the first SIP communication client calls the second SIP communication client.
